(19) United States
(12) Patent Application Publication
(10) Pub. No.: US 2012/0226567 A1
(43) Pub. Date: Sep. 6, 2012

(54) JOURNAL ISSUING SYSTEM AND JOURNAL ISSUING METHOD

(75) Inventor: Jun Iwamoto, Singapore (SG)

(73) Assignee: TOSHIBA TEC KABUSHIKI KAISHA, Tokyo (JP)

(21) Appl. No.: 13/406,890

(22) Filed: Feb. 28, 2012

(30) Foreign Application Priority Data
Mar. 2, 2011 (JP) 2011-45149

(51) Int. Cl. G06Q 20/20

(52) U.S. Cl. 705/24

(57) ABSTRACT

A journal issuing system includes a purchase data storing unit, a journal issue requesting unit, a purchase history searching unit, a purchase amount determining unit, and a purchase history outputting unit. The purchase data storing unit stores purchase data of a customer. The journal issue requesting unit requests issuance of a journal representing a purchase history of the customer. The purchase history searching unit searches for the purchase history of the customer stored in the purchase data storing unit, when the request of the issuance of the journal representing the purchase history of the customer is made. The purchase amount determining unit determines whether the purchase amount searched by the purchase history searching unit is equal to or greater than a predetermined value. The purchase history outputting unit outputs the purchase history of the customer if the purchase amount is equal to or greater than the predetermined value.

### CROSS-REFERENCE TO RELATED APPLICATIONS

This application is based upon and claims the benefit of priority from Japanese Patent Application No. 2011-045149, filed on Mar. 2, 2011, the entire contents of which are incorporated herein by reference.

### FIELD

Embodiments described herein relate generally to a journal issuing system and a journal issuing method for providing a customer with a receipt, which contains the details of product purchases, in the form of electronic data.

### BACKGROUND

When a customer purchases a product at a store, a paper receipt is issued and provided to the customer as evidence of the purchase. However, receipts are issued to all customers, regardless of the number and amount of products purchased. Therefore, when the customers do not require paper receipts, paper is wasted and the store suffers considerable loss.

In order to solve this problem, there have been proposed electronic receipt systems for providing a receipt in an electronic data format, which contains the details of product purchases.

### BRIEF DESCRIPTION OF THE DRAWINGS

FIG. 1 is a block diagram showing a system configuration according to an illustrative embodiment of the present disclosure.

FIG. 2 is a block diagram showing an example of a journal issuing device according to an illustrative embodiment.

FIG. 3 is a flow diagram showing a purchase process according to an illustrative embodiment.

FIG. 4 is a flow diagram showing a journal issuing process according to an illustrative embodiment.

FIG. 5 is a diagram showing an example of a purchase data storage format according to an illustrative embodiment.

FIG. 6 is a diagram showing an example of a purchase data transmission format according to an illustrative embodiment.

FIG. 7 is a diagram showing an example of the printout of a journal sorted by purchase dates according to an illustrative embodiment.

FIG. 8 is a diagram showing an example of the printout of a journal sorted by products according to an illustrative embodiment.

FIG. 9 is a diagram showing an example of the printout of a journal sorted by product categories according to an illustrative embodiment.

### DETAILED DESCRIPTION

According to one embodiment, a journal issuing system includes a purchase data storing unit, a journal issue requesting unit, a purchase history searching unit, a purchase amount determining unit, and a purchase history outputting unit. The purchase data storing unit is configured to store purchase data of a customer. The journal requesting unit is configured to request issuance of a journal representing a purchase history of the customer. The purchase history searching unit is configured to search for the purchase history of the customer stored in the purchase data storing unit, when the request for issuance of the journal representing the purchase history of the customer is made. The purchase amount determining unit is configured to determine whether the purchase amount of the customer searched by the purchase history searching unit is equal to or greater than a predetermined value. The purchase history outputting unit is configured to print out the purchase history of the customer if the purchase amount of the customer searched by the purchase history searching unit is equal to or greater than the predetermined value.

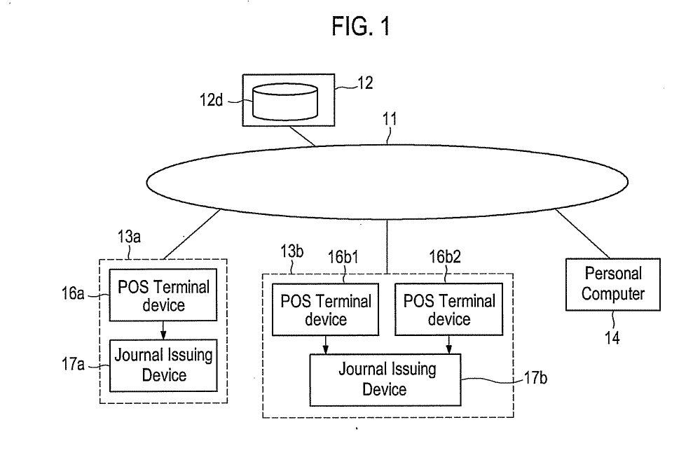

Exemplary embodiments will now be described in detail with reference to the accompanying drawings. FIG. 1 illustrates a journal issuing system according to an exemplary embodiment. The journal issuing system includes a purchase data storing server 12 connected to a network 11, purchase data inputting/outputting devices 13a and 13b, e.g., installed in stores, and connected to the network 11, and a personal computer 14 connected to the network 11. As used herein, the term “journal” refers to a paper statement containing purchase data representing a purchase history of a customer. Further, the “journal issuing system” refers to a system issuing or printing out the journal.

The purchase data inputting/outputting device 13a includes a Point-Of-Sale (POS) terminal device 16a and a journal issuing device 17a, and the purchase data inputting/outputting device 13b includes two terminal devices 16b1 and 16b2 and a journal issuing device 17b. As illustrated in FIG. 1, the purchase data inputting/outputting device may be installed in each store and include at least one POS terminal device and at least one journal issuing device. The number of POS terminal devices and the number of journal issuing devices installed in each store may increase with an increase in the size of the store, e.g., the number of customers shopping at the store. Although two purchase data inputting/outputting devices connected to the network is illustrated, three or more purchase data inputting/outputting devices may be connected to the network. The customer may have a member ID commonly used in the store.

When a customer makes a purchase, the POS terminal devices 16a, 16b1 and 16b2 input purchase data and a member ID of the customer and instructs the journal issuing devices 17a and 17b, e.g., to issue a journal(s).

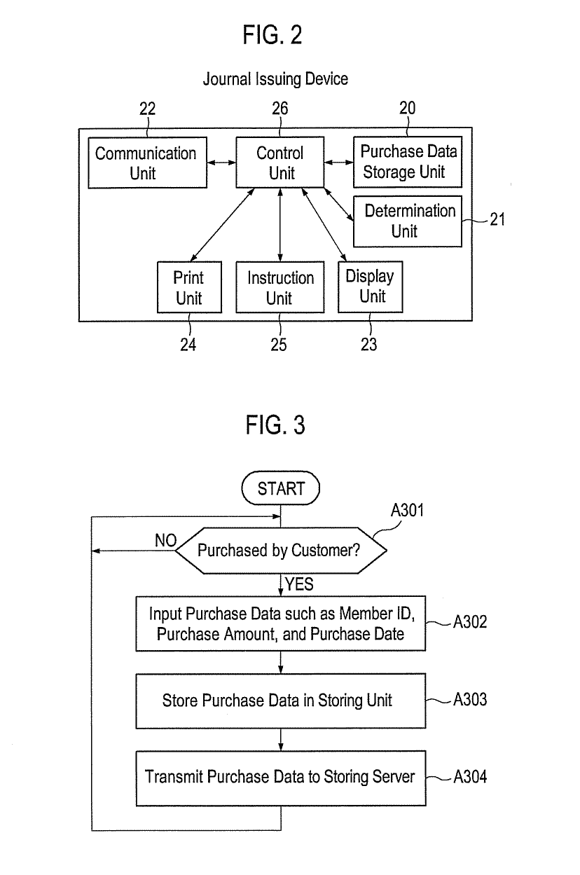

The journal issuing devices 17a and 17b store the purchase data and communicate with the purchase data storing server 12. For example, as illustrated in FIG. 2, each of the journal issuing devices 17a and 17b includes a purchase data storing unit 20 configured to store the purchase data inputted from the POS terminal device, a determination unit 21 configured to determine whether a journal issue condition is satisfied, a communication unit 22 configured to communicate with the purchase data storing server 12, a display unit 23 configured to display the purchase data, a print unit 24 configured to print the purchase data, an instruction unit 25 configured to send instructions to the journal issuing device, and a control unit 26 configured to control the entire operation of the above units.

The purchase data storing server 12 transmits the purchase data using the communication unit 22 of the journal issuing device of each store, and includes a database 12d configured to store the purchase data of each store and the purchase data (information) of each customer so that the stored purchase data can be retrieved at a later time. The determination unit 21 determines whether the journal issue condition is satisfied, e.g., a number of purchases or a purchase amount is equal to or greater than a predetermined value.

The personal computer 14 is connected to the network 11. If a customer inputs his member ID at the personal computer, e.g., installed at the customer's residence, the personal computer 14 receives purchase data of the customer from the purchase data storing server 12 and displays or prints out the received purchase data.

A process for making a purchase in a store by a customer and processing the purchase data in the journal issuing device will be described below in detail with reference to FIG. 3.

For example, it is assumed that a customer makes a purchase in a store (e.g., titled “∘∘ store”) provided with the journal issuing device 17a. If the purchase made by the customer is detected, e.g., by the POS terminal device 16a, in Act A301, the purchase data including the purchase history is inputted, e.g., by the POS terminal device 16a, in Act A302.

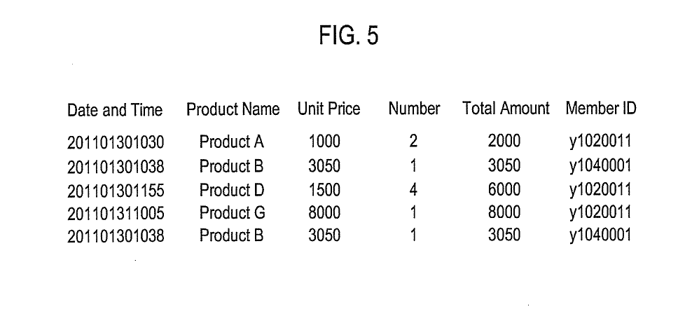

In this case, the purchase data including the purchase date and time, the product name, the unit price, the number of products purchased, the total purchase amount, and the member ID of the customer may be inputted from the POS terminal device 16a. An example of a data format of the purchase data is shown in FIG. 5. In this example, the first row indicates that a customer with a member ID of y1020011 purchases two $1,000 products for $2,000 at 10:30 on Jan. 30, 2011. In this manner, whenever the customer makes a purchase, purchase data are inputted from the POS terminal device 16a into the purchase data inputting/outputting device 13a. The member ID may be manually inputted by a clerk. Alternatively, in the case of an automatic accounting process, the member ID may be inputted automatically. The purchase data shown in FIG. 5 are temporarily stored in the purchase data storing unit 20 of the journal issuing device 17a shown in FIG. 2 (Act A303).

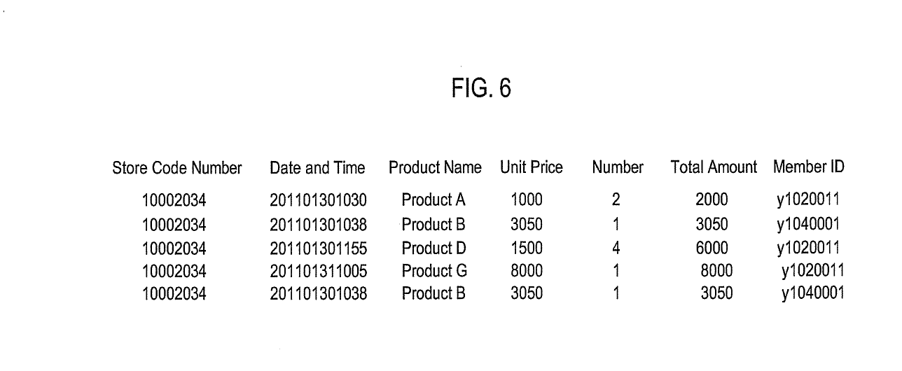

In Act A304, the purchase data is transmitted through the network 11 to the purchase data storing server 12. In this embodiment, the purchase data are transmitted along with a code number of the store (titled “∘∘ store”). For example, as illustrated in FIG. 6, the purchase data are accompanied with the code number ‘10002034’ of the store (titled “∘∘ store”). Accordingly, the purchase data storing server 12 can discern which one of the respective stores has sent the purchase data. For example, the purchase data may be constructed on the basis of the store code number, the member ID, the purchase date and the product name, which may be extracted from the database 12d.

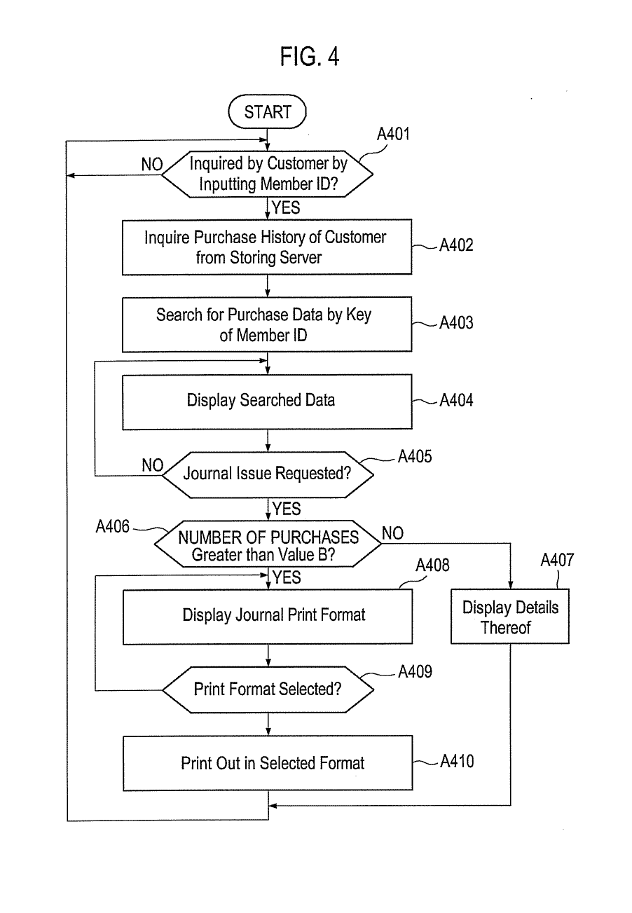

A process for requesting issuance of a journal (e.g., by a customer) in the journal issuing system according to an exemplary embodiment will be described below in detail with reference to FIG. 4.

As described above, all of the purchase data of the customer are transmitted from the respective stores to the purchase data storing server 12 along with the code numbers of the respective stores.

In Act A401 of FIG. 4, it is assumed that a customer has requested purchase data from the instruction unit 25 of the journal issuing device 17b. In response to this request, the journal issuing device 17b requests the purchase data associated with the member ID from the purchase data storing server 12 through the communication unit 22 (Act A402).

The purchase data storing server 12 searches the purchase information database 12d for the purchase data associated with the member ID (Act A403).

If the purchase data associated with the member ID is found, the purchase data is displayed on a display screen of the display unit 23 of the journal issuing device 17b in Act A404. Although not shown in FIG. 4, if no purchase data associated with the member ID is found, a message indicating the nonexistence of purchase data is displayed on the display unit 23.

If a journal issue request is received from the instruction unit 25 in Act A405, the determination unit 21 determines in Act A406 whether the number of purchases is equal to or greater than a predetermined value. In one embodiment, the determination unit 21 determines whether there is purchase data or whether the number of the purchase data is equal to or greater than a predetermined value B.

If the number of the purchase data is not greater than the predetermined value B (e.g., 4), the display unit 23 displays in Act A407 that a journal will not be issued because the number of the purchase data is not greater than the predetermined value.

On the other hand, if the number of the purchase data is equal to or greater than the predetermined value B (e.g., 4), a plurality of journal print formats is displayed on the display unit 23 in Act A408 and the customer may select one of the journal print formats (Act A409).

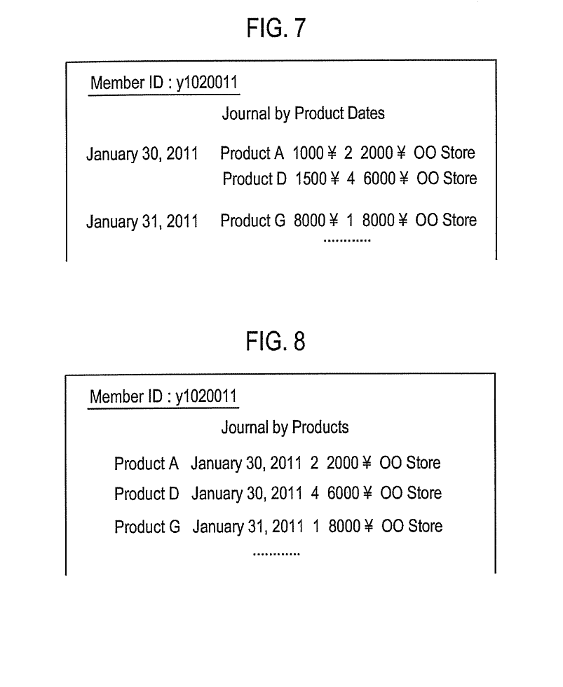

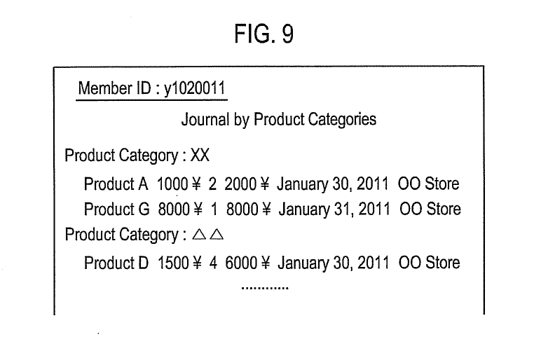

FIG. 7, FIG. 8 and FIG. 9 show examples of the journal print formats. FIG. 7 shows an example of the display of a journal where purchase data are sorted by purchase dates (which is referred to as “date-by-date journal format”). For example, the purchase product name, the unit price, the number of products purchased, the total purchase amount, and the purchase store name (titled “OO store”) are displayed for each purchase date. FIG. 8 shows an example of the display of a journal where purchase data are sorted by product names (which is referred to as “product-by-product journal format”). For example, the purchase date, the number of products purchased, the total purchase amount, and the purchase store name are displayed for each product name. FIG. 9 shows an example of the display of a journal where purchase data are sorted by product categories. For example, the purchase name, the unit price, the number of products purchased, the total purchase amount, the purchase date, and the purchase store name are displayed for each product category.

In Act A409, for example, it is assumed that a customer with a member ID of y1020011 has selected the product-by-product journal format of FIG. 8 as the print format on the display screen of the display unit 23 of the journal issuing device 17b. In this case, the product-by-product journal format of FIG. 8 is printed out by the print unit 24 of the journal issuing device 17b in Act A410. After the journal is issued in the selected format, the system returns to Act A401 and waits for a request from a customer. As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a Solid-state computer storage media. The functions obtained by installation or download in advance in this way can be realized in cooperation with an OS(Operating System) or the like in the apparatus.

In the above embodiment, it is illustrated that the number of journal print formats is three. However, the number of journal print formats may be two (e.g., date-by-date and product-by-product, or date-by-date and store-by-store), or the user may select a print format from four or more print formats. Also, the selection of the print format may be optional, and one predetermined print format may also be provided.

In the above embodiment, it is illustrated that a journal is issued when the number of purchases is equal to or greater than a predetermined value. However, the journal may be issued based on any other purchase conditions such as the total purchase amount, the number of purchases in a specific store, the purchase date, or the product category. Also, instead of inputting the member ID, the name of the customer may be designated to perform a journal printout. Further, a journal may be printed for a plurality of customers.

In the above embodiment, no limitation is defined on a period for which the issuance of a journal may be allowed. However, a journal issuance or printout may be performed only within a predefined period.

In the above embodiment, it is illustrated that the POS terminal device is used to input the purchase data of a customer. However, the present disclosure is not limited to the POS terminal device, but it may be any terminal device that can input the purchase data of a customer.

According to the above embodiments, it is possible to issue a journal at a store if purchase data associated with a customer (requesting a purchase history) satisfy a predetermined condition.

While certain embodiments have been described, these embodiments have been presented by way of example only, and are not intended to limit the scope of the disclosures. Indeed, the novel journal issuing systems and devices described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the disclosures.

What is claimed is:

1. A journal issuing system comprising:
a purchase data storing unit configured to store purchase data of a customer;
a journal requesting unit configured to request issuance of a journal representing a purchase history of the customer;
a purchase history searching unit configured to search for the purchase history of the customer stored in the purchase data storing unit, when the request for the issuance of the journal representing the purchase history of the customer is made;
a purchase amount determining unit configured to determine whether a purchase amount included in the purchase history searched by the purchase history searching unit is equal to or greater than a predetermined value; and
a purchase history outputting unit configured to output the purchase history of the customer if the purchase amount is equal to or greater than the predetermined value.

2. A journal issuing system comprising:
a purchase data inputting/outputting device connected to a network to receive purchase data of a customer in a store and output a history of the purchase data; and
a purchase data storing server connected to the network to store the purchase data received from the purchase data inputting/outputting device,
wherein the purchase data inputting/outputting device comprises:
a terminal device configured to input the purchase data of the customer; and
a journal issuing device configured to determine whether a journal issue condition is satisfied when a purchase data output request is received from the customer, and configured to output a journal representing the history of the purchase data if the journal issue condition is satisfied.

3. The system of claim 2, wherein the terminal device is a Point-Of-Sale (POS) terminal device.

4. The system of claim 3, wherein a format for outputting the journal is selected from a plurality of data formats.

5. The system of claim 4, wherein the journal issuing device comprises:
a communication unit configured to communicate the purchase data with the purchase data storing server;
a purchase data storing unit configured to store the purchase data of the customer;
a determination unit configured to determine whether the journal issue condition is satisfied if the purchase data output request is received from the customer;
an instruction unit configured to select the format for outputting the journal;
a display unit configured to display the journal in the selected format if it is determined by the determination unit that the journal issue condition is satisfied; and
a print unit configured to print the purchase data of the customer in the selected format.

6. The system of claim 5, wherein the journal issue condition is whether the purchase amount is equal to or greater than a predetermined value.

7. The system of claim 5, wherein the journal issue condition is whether a number of purchases or purchase price is equal to or greater than a predetermined value.

8. A journal issuing method comprising:
connecting through a network to a purchase data storing server which stores purchase data of a customer;
determining whether the purchase data satisfies a journal output condition if a purchase data output request is received from a customer; and
outputting a journal representing a history of the purchase data if the purchase data satisfies the journal output condition.

9. The method of claim 8, wherein the journal output condition is whether a purchase amount is equal to or greater than a predetermined value.

10. The method of claim 9, wherein the journal issue condition is whether a number of purchases or purchase price is equal to or greater than a predetermined value.
